(19) United States
(12) Patent Application Publication
(10) Pub. No.: US 2003/0205971 A1
(43) Pub. Date: Nov. 6, 2003

(54) Organic light-emitting diode device with a function of lateral light utilization, method for utilizing the same and device with information display and back-light effect

(76) Inventors: Mei-Ying Chang, Hsin Chu City (TW); Yi Chang, Hsin Chu City (TW); Jiun-Haw Lee, Hsin Chu City (TW); Mao-Kuo Wei, Hsin Chu City (TW)

Correspondence Address: BIRCH STEWART KOLASCH & BIRCH, PO BOX 747, FALLS CHURCH, VA, 22040-0747, US

(21) Appl. No.: 10/427,904

(22) Filed: May 2, 2003

(30) Foreign Application Priority Data
May 3, 2002 (TW) 091109312
May 3, 2002 (TW) 091206291
May 3, 2002 (TW) 091206292

(51) Int. Cl. H05B 33/00

(52) U.S. Cl. 313/506

(57) ABSTRACT

An organic light-emitting diode device with a function of lateral light utilization. The device includes a transparent substrate, a first electrode, at least one organic light-emitting layer, a second electrode, and a wave-guide layer. In this case, the first electrode is formed on the transparent substrate, the organic light-emitting layer is formed on the first electrode, and the second electrode is formed on the organic light-emitting layer. The wave-guide layer is adjacent to the transparent substrate, and the wave-guide layer and the transparent substrate are located at the same layer in the organic light-emitting diode device. Furthermore, the invention also discloses a device with information display and back-light effect, which includes a light emitter and a wave-guide element. The wave-guide element transmits lateral light of the light-emitter outward, and the outputted lateral light is used as a light source.

### BACKGROUND OF THE INVENTION

1. Field of Invention

The invention relates to an organic light-emitting diode device with a function of lateral light utilization, and in particular, to an organic light-emitting diode device that has a wave-guide layer and a device with information display and back-light effect that employs the organic light-emitting diode device.

2. Related Art

In general, a device with information display and back-light effect includes a screen, such as an LCD (Liquid Crystal Display), for displaying information. The LCD employs LEDs (Light-emitting Diodes) or other light source as its back-light source, so as to display information.

However, the conventional device with information display and back-light effect includes a further back-light source for other objectives such as key illumination. In such a case, the back-light source and the screen are separated and independent components. For instance, as shown in FIG. 1, a conventional mobile communication device 5, such as a mobile phone, has a screen panel 51, which is an LCD. The back-light source of the phone keys 52 must be a further light-emitting diode other than the back-light source of the screen panel 51. Since two back-light components are necessary, the cost of the mobile communication device 5 is increased. Moreover, it is difficult to maintain and repair the mobile communication device 5. Additionally, the back-light source of the phone keys 52 is a light-emitting diode, resulting in that the phone keys 52 must be convex structures. This is unsuitable for the current trend toward more compact and thin mobile phones.

Recently, industries employ organic light-emitting diodes as the back-light source of screen since organic light-emitting diodes are well developed. Because the organic light-emitting diodes are self-emissive, are easily manufactured, and are low cost, they are potential products in the future.

In a conventional organic light-emitting diode device, the refraction index of a transparent substrate n₂ (≈1.4-1.5) is larger than that of air n₁ (≈1). According to Snell's Law, when a beam of light goes through an interface, the product of the refraction index and the sine of the incident angle in the incident medium are equal to that in the refractive medium. When a beam of light propagates out from the transparent substrate and the incident angle is greater than sin⁻¹(1/n₂), the light will be totally reflected. The light is restricted to propagation within the transparent substrate, resulting in the substrate wave-guide phenomenon. One thus sees that only part of the light generated by the organic light-emitting diode device that can propagate out of the element. The rest results in the substrate wave-guide phenomenon inside the substrate. Therefore, the light flux emitted from the organic light-emitting diode device is obviously less than that generated by an organic light-emitting layer inside the organic light-emitting diode device.

### SUMMARY OF THE INVENTION

In view of the above-mentioned problems, an objective of the invention is to provide an organic light-emitting diode device that can output lateral light of a transparent substrate and reuse the outputted lateral light.

A further objective of the invention is to provide a device with information display and back-light effect, which is able to transmit lateral light of an organic light-emitting diode device outward to be a back-light source.

To achieve the above objectives, an organic light-emitting diode device with a function of lateral light utilization includes a transparent substrate, a first electrode, at least one organic light-emitting layer, a second electrode, and a wave-guide layer. In this invention, the first electrode is formed on the transparent substrate, the organic light-emitting layer is formed on the first electrode, and the second electrode is formed on the organic light-emitting layer. The wave-guide layer and the transparent substrate are adjacent to each other and are located at the same layer in the organic light-emitting diode device.

Furthermore, the invention also provides a device with information display and back-light effect, which includes a light emitter- and a wave-guide element. In the invention, the wave-guide element transmits lateral light of the light emitter outward, so that the outputted lateral light is used as a light source.

Since the light flux generated by the organic light-emitting layer is mainly restricted to propagation within the transparent substrate of the organic light-emitting diode device, only little light flux is transmitted outward. According to this invention, the organic light-emitting diode device with a function of lateral light utilization employs a wave-guide layer to output the light flux rested inside the transparent substrate. The outputted lateral light can be used as a light source, or used for other purpose. Compared with conventional technologies, the invention can increase reuse of light so as to increase the efficiency of the entire device. Furthermore, the device with information display and back-light effect of the invention can utilize the optical wave-guide element to transmit the lateral light, which serves as a light source, outward. For example, the lateral light serves as a back-light source for key illumination of a mobile communication device or a personal mobile assistant device. Compared with conventional technologies, the device with information display and back-light effect of the invention is capable of integrating a display with a back-light panel. Since the outputted lateral light serves as the back-light source of phone keys, it is unnecessary to provide another light-emitting diode component, resulting in reduction of production cost. In addition, the mobile communication device becomes thinner when the additional light-emitting diode component for back-light source of phone keys is eliminated. Thus, the mobile communication device can be made more planar and more compact.

### BRIEF DESCRIPTION OF THE DRAWINGS

The invention will become more fully understood from the detailed description given in the hereinbelow illustration, and thus are not limitative of the present invention, and wherein:

FIG. 1 is a schematic view of the conventional mobile communication device;

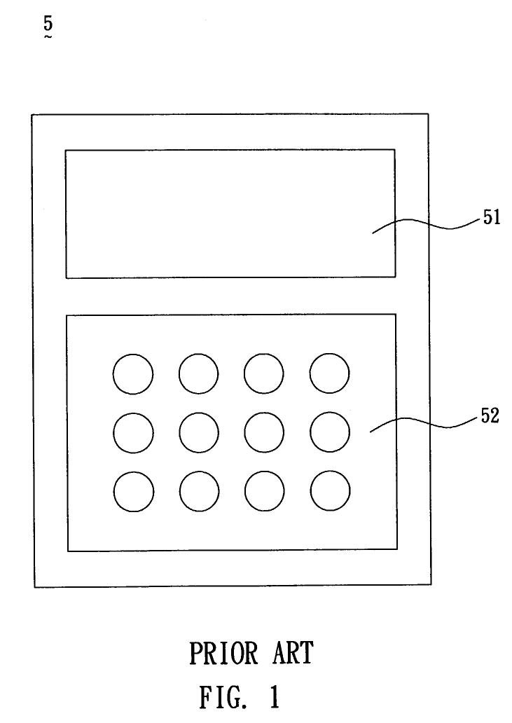

FIGS. 2a and 2b are schematic views showing organic light-emitting diode devices with a function of lateral light utilization according to two first embodiments of the invention;

FIG. 3 is a schematic illustration showing the paths of the lateral light propagated within the organic light-emitting diode device with a function of lateral light utilization according to a first embodiment of the invention;

FIGS. 4a and 4b are schematic views showing organic light-emitting diode devices with a function of lateral light utilization according to two additional first embodiments of the invention, which further includes a prism;

FIGS. 5a and 5b are schematic views showing organic light-emitting diode devices with a function of lateral light utilization according to two additional first embodiments of the invention, which further includes a diffuse layer;

FIGS. 6a and 6b are schematic views showing organic light-emitting diode devices with a function of lateral light utilization according to two additional first embodiments of the invention, which further includes a reflecting layer;

FIG. 7 is a schematic view showing an organic light-emitting diode device with a function of lateral light utilization, which carries out a method for utilizing lateral light of the organic light-emitting diode according to a second embodiment of the invention;

FIG. 8 is a schematic view showing another organic light-emitting diode device with a function of lateral light utilization, which carries out a method for utilizing lateral light of the organic light-emitting diode according to an additional second embodiment of the invention;

FIG. 9 is a schematic view showing another organic light-emitting diode device with a function of lateral light utilization, which carries out a method for utilizing lateral light of the organic light-emitting diode according to a further second embodiment of the invention, wherein the first wave-guide element further includes a second wave-guide element; and

FIG. 10 is a schematic view showing an organic light-emitting diode device with a function of lateral light utilization employed in a device with information display and back-light effect according to a third embodiment of the invention.

### DETAILED DESCRIPTION OF THE INVENTION

The present invention will be apparent from the following detailed description, which proceeds with reference to the accompanying drawings, wherein the same references relate to the same elements.

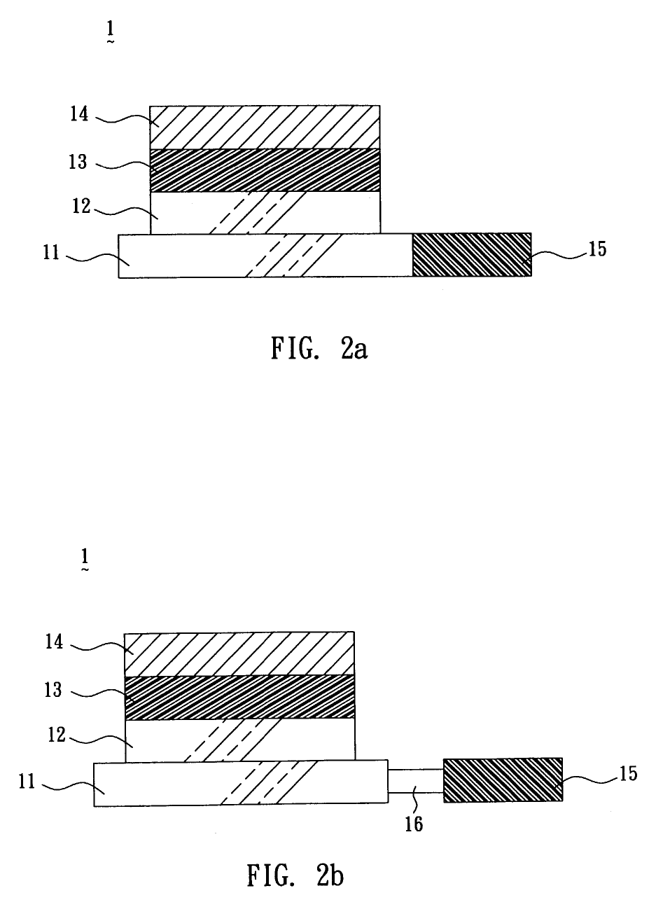

Referring to FIG. 2a, an organic light-emitting diode device with a function of lateral light utilization 1 according to a first embodiment of the invention includes a transparent substrate 11, a first electrode 12, an organic light-emitting layer 13, a second electrode 14, and a wave-guide layer 15. In this embodiment, the second electrode 12 is formed on the transparent substrate 11, the organic light-emitting layer 13 is formed on the first electrode 12, and the second electrode 14 is formed on the organic light-emitting layer 13. The wave-guide layer 15 is located adjacent to the transparent substrate 11, wherein the wave-guide layer 15 and the transparent substrate 11 are positioned at the same layer in the organic light-emitting diode device with a function of lateral light utilization 1.

The transparent substrate 11 can be a glass substrate, a plastic substrate or a flexible substrate. In this case, the plastic substrate or the flexible substrate is a polycarbonate (PC) substrate, a polyester (PET) substrate, a cyclic olefin copolymer (COC) substrate, or a metallocene-based cyclic olefin copolymer (mCOC).

The first electrode 12 of the embodiment is a transparent anode, which is formed on the transparent substrate 11 by method of sputtering or ion plating. The first electrode 12 is made of a conductive metal oxide such as indium-tin oxide (ITO) or aluminum-zinc oxide (AZO). The thickness of the first electrode 12 is above 500 Å.

The organic light-emitting layer 13 is formed on the first electrode 12 by method of evaporation, spin coating, ink jet printing or printing. Its thickness is between 500 Å and 3000 Å. The light emitted by the organic light-emitting layer 13 may be blue, green, red, other monochrome, or white light.

The second electrode 14 of the embodiment is a metal cathode, which is formed on the organic light-emitting layer 13 by method of evaporation or sputtering. Its thickness is between 500 Å and 5000 Å. In the current embodiment, the second electrode 14 is made of aluminum, aluminum/lithium fluoride, calcium, magnesium-silver alloys or silver.

The wave-guide layer 15 of the current embodiment, as shown in FIG. 2a, is connected to the transparent substrate 11. In this embodiment, three lateral side surfaces of the transparent substrate 11, which are unconnected to the wave-guide layer 15, are attached with reflecting stripes, which is made of acrylics. Thus, the light restricted inside the transparent substrate 11 can be propagated to the wave-guide layer 15. Alternatively, the wave-guide layer 15 and the transparent substrate 11 can be separated, and a photonics component 16 is provided to connect the wave-guide layer 15 and transparent substrate 11 (as shown in FIG. 2b).

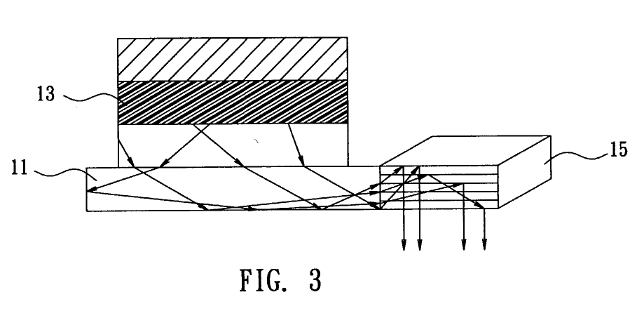

The wave-guide layer 15 is mainly consisted of acrylic acid resin such as polymethyl methacrylate (PMMA), which has a refraction index of 1.49 and a critical angle of total reflection of about 42 degrees. The light generated by the organic light-emitting layer 13 has good penetration ratio to the wave-guide layer 15. In the current embodiment, the wave-guide layer 15 is used to transmit the light generated by the organic light-emitting layer 13 and restricted inside the transparent substrate 11 outward. As a result, the light can be fully utilized. FIG. 3 shows the paths of the lateral light propagated within the transparent substrate 11.

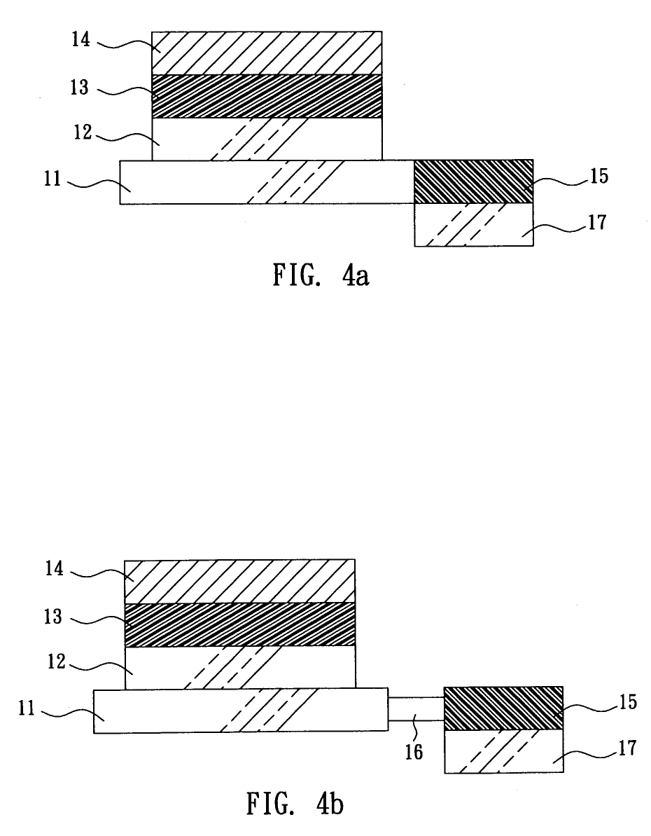

With reference to FIGS. 4a and 4b, the organic light-emitting diode device with a function of lateral light utilization 1 further includes a prism 17, which is provided at one side of the wave-guide layer is. In the present embodiment, the prism 17 is positioned below the wave-guide layer 15 for enhancing intensity of the transmitted lateral light.

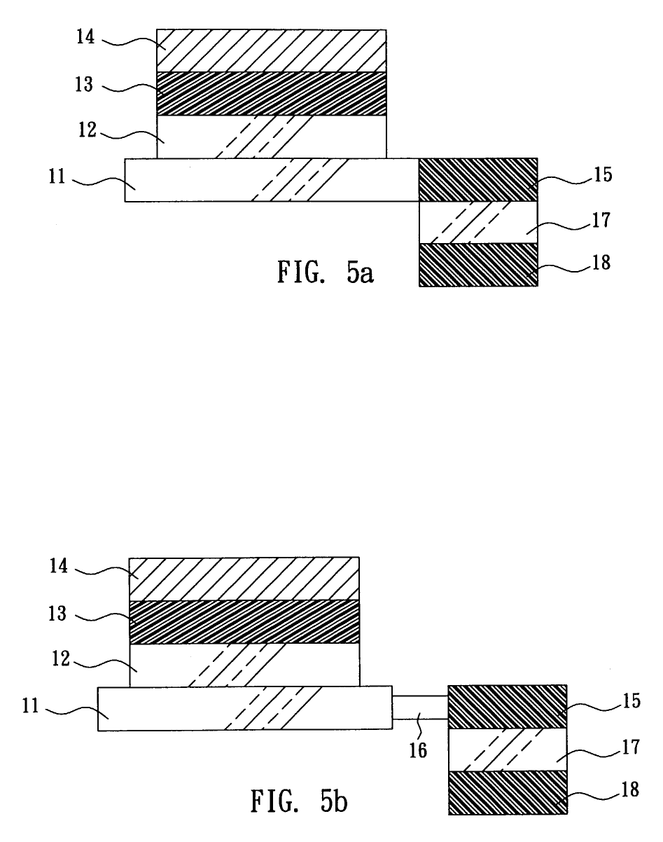

Referring to FIGS. 5a and 5b, the organic light-emitting diode device with a function of lateral light utilization I further includes a diffuse layer 18, which is provided at one side of the prism 17 for uniforming the transmitted lateral light. In this embodiment, the diffuse layer 18 is made of polyethylene glycol, which is coated with polymethyl methacrylate.

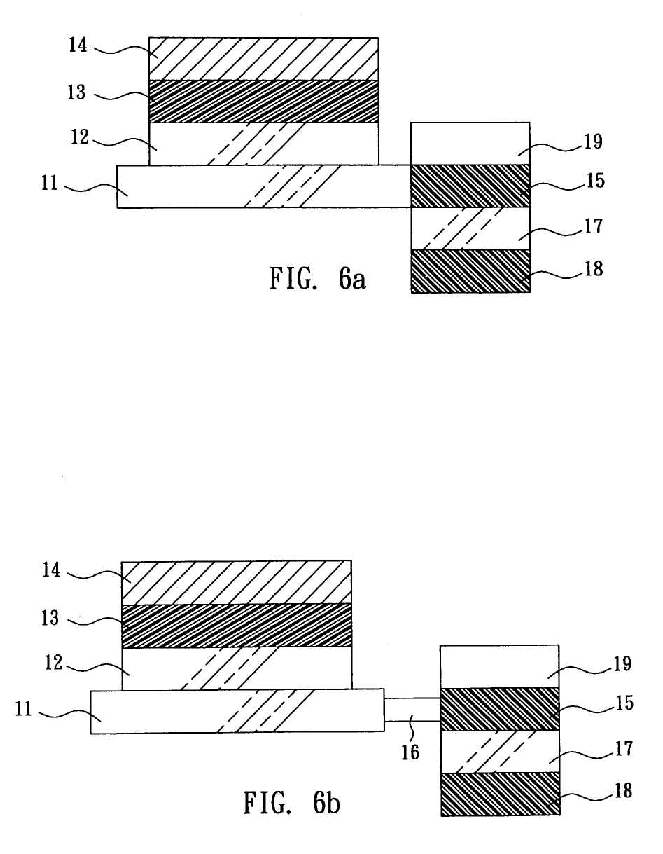

In addition, as shown in FIGS. 6a and 6b, the organic light-emitting diode device with a function of lateral light utilization 1 further includes a reflecting layer 19, which is provided at another side of the wave-guide layer 15 opposite to the prism 17. In the current embodiment, the reflecting layer 19 is positioned above the wave-guide layer 15 for controlling the direction of the transmitted lateral light.

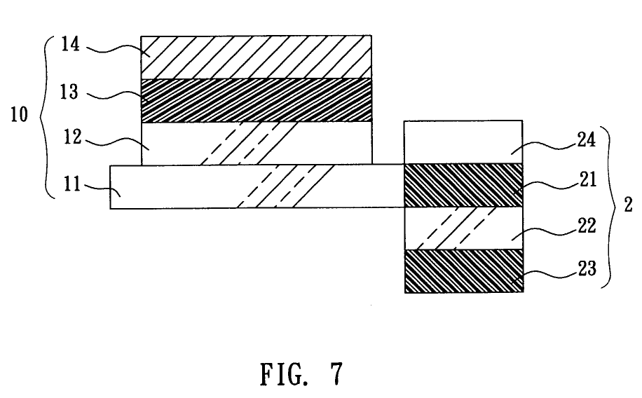

The invention also provides a method for utilizing lateral light of an organic light-emitting diode (as shown in FIG. 7), which employs a first wave-guide element 2 to transmit the lateral light of the transparent substrate 11 of the organic light-emitting diode 10 outward, so that the outputted lateral light can be a light source.

The organic light-emitting diode 10 includes the previous-mentioned transparent substrate 11, first electrode 12, organic light-emitting layer 13, and second electrode 14. Thus, this specification would not illustrate them in more detail hereinbelow.

In the current embodiment, the first wave-guide element 2 includes a wave-guide layer 21, a prism 22, a diffuse layer 23, and a reflecting layer 24, which are similar to the mentioned wave-guide layer 15, prism 17, diffuse layer 18, and reflecting layer 19. Thus, this specification would not illustrate them in more detail hereinbelow.

The first wave-guide element 2 is utilized to transmit the lateral light of the transparent substrate 11 outward, so that the lateral light can be a light source and be reused. For example, the lateral light can be used as a back-light of phone keys. Thus, the efficiency of light generated by the organic light-emitting layer 13 is increased.

The wave-guide layer 21 of the current embodiment is connected to the transparent substrate 11, and the wave-guide layer 21 and the transparent substrate 11 are provided at the same layer. In this embodiment, three lateral side surfaces of the transparent substrate 11, which are unconnected to the wave-guide layer 21, are attached with reflecting stripes, which is made of acrylics. Thus, the light restricted inside the transparent substrate 11 can be propagated to the wave-guide layer 21.

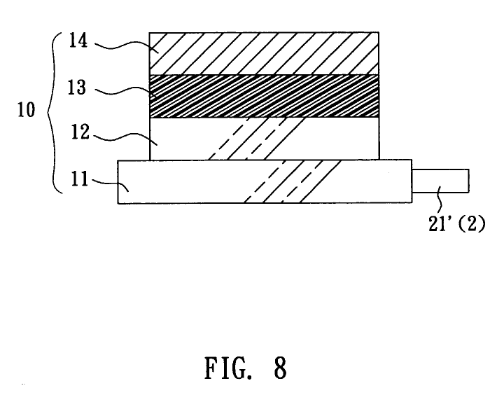

Alternatively, the first wave-guide element 2 of the embodiment can be a photonics component 21′ (as shown in FIG. 8). The photonics component 21′ of the embodiment, for example, is an optical fiber.

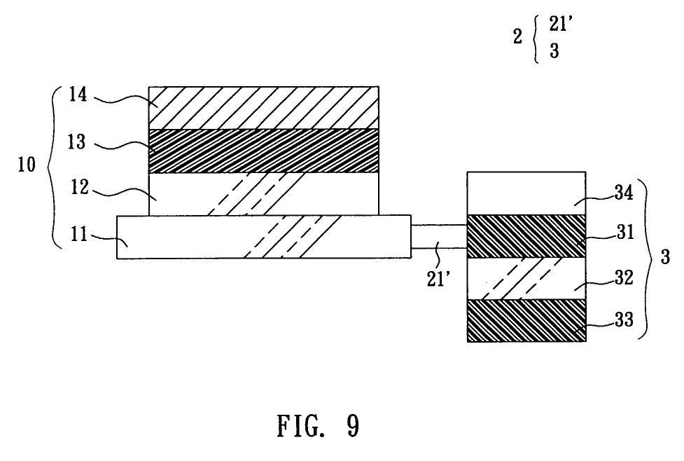

As mentioned above, the first wave-guide element 2 may further include a second wave-guide element 3 as shown in FIG. 9. The wave-guide element 3 includes a wave-guide layer 31, which is similar to the mentioned wave-guide layer 21. The second wave-guide element 3 may further include a prism 32, a diffuse layer 33, and a reflecting layer 34, which are similar to the mentioned prism 22, diffuse layer 23, and reflecting layer 24.

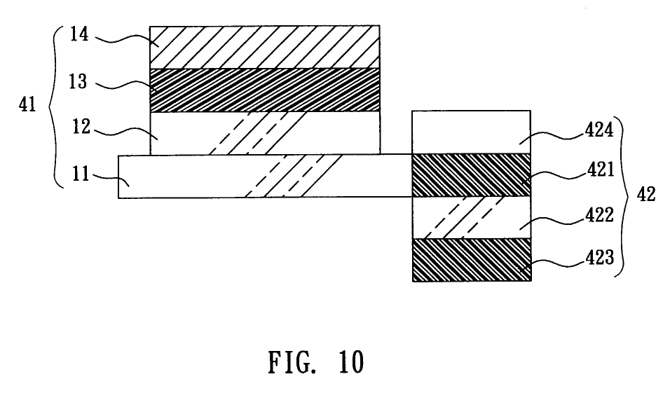

In the third embodiment of the invention, a device with information display and back-light effect 4 includes a light emitter 41 and an wave-guide element 42 (as shown in FIG. 10). The wave-guide element 42 transmits lateral light of the light emitter 41 outward, so that the transmitted lateral light can be a light source.

In the current embodiment, the light emitter 41 is the organic light-emitting diode 10 shown in FIG. 7, so this specification would not illustrate it in more detail hereinbelow.

In this embodiment, the light emitter 41 can be used in a screen of a mobile communication device or personal mobile assistant device. For example, the mentioned mobile communication device can be a mobile phone, a pager, or a stock information appliance, and the personal mobile assistant device is a PDA. The invention can also be applied to a telephone with a screen, a translation device with a screen, and a portable data processor such as a notebook computer.

Since the organic light-emitting diode is self-emissive, is high power efficient, have a full viewing angle in practice, are easily manufactured, are low cost, and are full color, it is superior to other emitting devices.

With reference to FIG. 10, the optical conductor 42 transmits the lateral light of the light emitter 41 outward, so that the transmitted lateral light can be a light source. In the embodiment, the optical conductor 42 includes a wave-guide layer 421, a prism 422, a diffuse layer 423, and a reflecting layer 424.

In this embodiment, the wave-guide element 42 is similar to the first wave-guide element 2 of the second embodiment, so that this specification would not illustrate it in more detail hereinbelow.

This invention can be applied to mobile communication devices and personal mobile assistant devices. When the organic light-emitting diode 41 is employed to be a back-light source of a screen, the wave-guide element 42 can transmit the lateral light of the transparent substrate 11 outward as the lateral light serves as an additional back-light source of a mobile communication device or personal mobile assistant device. For instance, the transmitted lateral light is a back-light source for key illumination. Accordingly, the lateral light can replace the back-light source for key illumination provided by the conventional light-emitting diode, and the cost of the entire device is reduced. In addition, the device becomes thinner when the additional light-emitting diode, which is convex structure, is eliminated. Thus, the entire device can be made more planar and more compact.

The organic light-emitting diode device with a function of lateral light utilization of the invention can transmit the light flux restricted within the transparent substrate outward, so that the outputted lateral light can be a light source and be reused efficiently. For example, the outputted lateral light can be applied to the phone keys. Compared with conventional technologies, the organic light-emitting diode device with a function of lateral light utilization of the invention employs a wave-guide layer to transmit the light flux rested inside the transparent substrate. The outputted lateral light can be used as a light source, or be used for other purpose. Thus, the organic light-emitting diode device with a function of lateral light utilization of the invention can enhance the efficiency itself, and decrease the cost of the entire device. Furthermore, the organic light-emitting diode device with a function of lateral light utilization of the invention can be applied to mobile communication devices and personal mobile assistant devices. When the organic light-emitting diode device with a function of lateral light utilization of the invention is employed as a back-light source of a screen of a mobile communication device or a personal mobile assistant device, the lateral light can be transmitted outward by the wave-guide element and become an additional back-light source such as a back-light source of phone keys. Compared with conventional technologies, the device with information display and back-light effect of the invention is capable of integrating a display with a back-light panel. Since the outputted lateral light serves as the back-light source of phone keys, it is unnecessary to provide a further light-emitting diode component, resulting in the reduction of production cost. In addition, the mobile communication device becomes thinner when the additional light-emitting diode component for back-light source of phone keys is eliminated. Thus, the mobile communication device can be made more planar and more compact.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An organic light-emitting diode device with a function of lateral light utilization, comprising:
a transparent substrate;
a first electrode formed on the transparent substrate;
at least one organic light-emitting layer formed on the first electrode;
a second electrode formed on the organic light-emitting layer; and
a wave-guide layer, which is positioned adjacent to the transparent substrate, the wave-guide layer and the transparent substrate are located at the same layer in the organic light-emitting diode device.

2. The organic light-emitting diode device of claim 1, further comprising:
a prism provided at one side of the wave-guide layer for enhancing the intensity of the transmitted lateral light.

3. The organic light-emitting diode device of claim 1, further comprising:
a diffuse layer provided at one side of the wave-guide layer for uniforming the transmitted lateral light.

4. The organic light-emitting diode device of claim 1, further comprising:
a reflecting layer provided at one side of the wave-guide layer for controlling the direction of the transmitted lateral light.

5. The organic light-emitting diode device of claim 1, wherein the wave-guide layer is connected to the transparent substrate.

6. The organic light-emitting diode device of claim 1, wherein the wave-guide layer is unconnected to the transparent substrate.

7. The organic light-emitting diode device of claim 6, further comprising:
a photonics component for connecting the wave-guide layer to the transparent substrate.

8. A method for utilizing lateral light of an organic light-emitting diode, wherein the organic light-emitting diode comprises a transparent substrate, the method comprising outputting the lateral light of the transparent substrate with a first wave-guide element, the lateral light being outputted and used as a light source.

9. The method of claim 8, wherein the first wave-guide element comprises a wave-guide layer.

10. The method of claim 9, wherein the first wave-guide element further comprises:
a prism for enhancing the intensity of the transmitted lateral light.

11. The method of claim 9, wherein the first wave-guide element further comprises:
a diffuse layer for uniforming the transmitted lateral light.

12. The method of claim 9, wherein the first wave-guide element further comprises:
a reflecting layer for controlling the direction of the transmitted lateral light.

13. The method of claim 9, wherein the wave-guide layer and the transparent substrate are located at the same layer in the organic light-emitting diode.

14. The method of claim 9, wherein the wave-guide layer is connected to the transparent substrate.

15. The method of claim 8, wherein the first wave-guide element is a photonics component.

16. The method of claim 15, wherein the photonics component is an optical fiber.

17. The method of claim 8, wherein the first wave-guide element further comprises a second wave-guide element.

18. The method of claim 17, wherein the second wave-guide element is a wave-guide layer.

19. The method of claim 18, wherein the second wave-guide element further comprises a prism.

20. The method of claim 18, wherein the second wave-guide element further comprises a diffuse layer.

21. The method of claim 18, wherein the second wave-guide element further comprises a reflecting layer.

22. A device with information display and back-light effect, comprising:
a light emitter; and
a wave-guide element for transmitting lateral light of the light emitter.

23. The device of claim 22, wherein the light emitter is an organic light-emitting diode comprising a transparent substrate, a first electrode, at least one organic light-emitting layer, and a second electrode.

24. The device of claim 22, wherein the wave-guide element comprises a wave-guide layer.

25. The device of claim 22, wherein the wave-guide element comprises a prism.

26. The device of claim 22, wherein the wave-guide element comprises a diffuse layer.

27. The device of claim 22, wherein the wave-guide element comprises a reflecting layer.

28. The device of claim 24, wherein the light emitter is an organic light-emitting diode comprising a transparent substrate, a first electrode, at least one organic light-emitting layer, and a second electrode, the wave-guide layer and the transparent substrate being located at the same layer in the device.

29. The device of claim 28, wherein the wave-guide layer is connected to the transparent substrate.

30. The device of claim 28, wherein the wave-guide layer is unconnected to the transparent substrate.

31. The device of claim 30, further comprising a photonics component for connecting the wave-guide layer to the transparent substrate.
